(19) United States
(12) Patent Application Publication
(10) Pub. No.: US 2014/0309997 A1
(43) Pub. Date: Oct. 16, 2014

(54) Information Processing Apparatus and Control Method

(71) Applicant: KABUSHIKI KAISHA TOSHIBA, Tokyo (JP)

(72) Inventor: Tomohiro Hanyu, Ome-shi (JP)

(73) Assignee: KABUSHIKI KAISHA TOSHIBA, Tokyo (JP)

(21) Appl. No.: 14/180,236

(22) Filed: Feb. 13, 2014

(30) Foreign Application Priority Data
Apr. 15, 2013 (JP) 2013-085231

(51) Int. Cl. G10L 25/93

(52) U.S. Cl. CPC G10L 25/93
USPC 704/258

(57) ABSTRACT

One embodiment provides an information processing apparatus, including: a sound synthesizer configured to output a combined sound signal of an alarm sound signal and a remaining sound signal other than the alarm sound signal; a sound separator configured to separate the combined sound signal into a human voice signal and a background sound signal; an alarm sound detector configured to detect whether a background sound corresponding to the background sound signal output from the sound separator includes an alarm sound or not; and an alarm sound receiver configured to, when the alarm sound detector detects that the background sound includes the alarm sound, read the alarm sound signal corresponding to the detected alarm sound, and further combine the read alarm sound signal with the combined sound signal to thereby output an adjusted combined sound signal.

### CROSS-REFERENCE TO RELATED APPLICATION(S)

This application claims priority (priorities) from Japanese Patent Application No. 2013-085231 filed on Apr. 15, 2013, the entire contents of which are incorporated herein by reference.

### FIELD

Embodiments described herein relate generally to an information processing apparatus and a control method.

### BACKGROUND

For example, sound separation techniques can separate a human voice and a background sound from a mixed sound, and can make the human voice easier to hear by inputting, to a speaker, a signal in which the volume of the background sound is lowered.

For example, in PCs, every sound to be emitted from the system is combined by a mixer (a sound synthesizer implemented by software). A TV sound signal and an alarm sound signal generated by the system are combined together by the mixer and a resulting signal is output to the speakers.

In such systems, an effector (effect unit) which performs a sound separation technique etc. is disposed between the mixer and the speakers. This effector receives a sound signal combined by the mixer, performs audio signal processing on it, and outputs a resulting sound signal to the speakers. A typical sound effect is a surround effect (addition of a sound that causes a listener to feel a sense of expanse).

In such systems as PCs, any of various sound signals generated by the system is combined by the mixer with a signal of an alarm sound to be given to the user from the system. In sound separation techniques, an alarm sound tends to be judged a background sound. As a result, for example, since the volume of a background sound may be lowered to make a human voice easier to hear, the volume of an alarm sound may also be lowered, thereby making it difficult for the user to hear.

There is demand for a method for preventing an alarm sound from being lowered. On the other hand, in mobile equipment etc., audio processing for sound quality improvement will mainly be implemented by software.

In view of above, there is provided a technique that a sound signal incorporated with an alarm sound signal is filtered to make a particular sound (having a certain frequency) easier to hear and a technique that a signal from which a guide notification sound (alarm sound) is separated in advance is combined with a TV sound signal before being output to the speakers. However, no technique capable of solving the above problem is known yet.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 is a perspective view showing an appearance of a notebook computer according to a first embodiment.

FIG. 2 is a block diagram showing the configuration of an essential part of the notebook computer according to the first embodiment.

FIG. 3 is a functional block diagram of a system according to the first embodiment.

FIG. 4 is a flowchart of an audio signal process which is executed in the first embodiment.

FIG. 5 is a functional block diagram of a system according to a second embodiment.

FIG. 6 is a functional block diagram of a system according to a third embodiment.

FIG. 7 is a functional block diagram of a system according to a fourth embodiment.

### DETAILED DESCRIPTION

One embodiment provides an information processing apparatus, including: a sound synthesizer configured to output a combined sound signal of an alarm sound signal and a remaining sound signal other than the alarm sound signal; a sound separator configured to separate the combined sound signal into a human voice signal and a background sound signal; an alarm sound detector configured to detect whether a background sound corresponding to the background sound signal output from the sound separator includes an alarm sound or not; and an alarm sound receiver configured to, when the alarm sound detector detects that the background sound includes the alarm sound, read the alarm sound signal corresponding to the detected alarm sound, and further combine the read alarm sound signal with the combined sound signal to thereby output an adjusted combined sound signal.

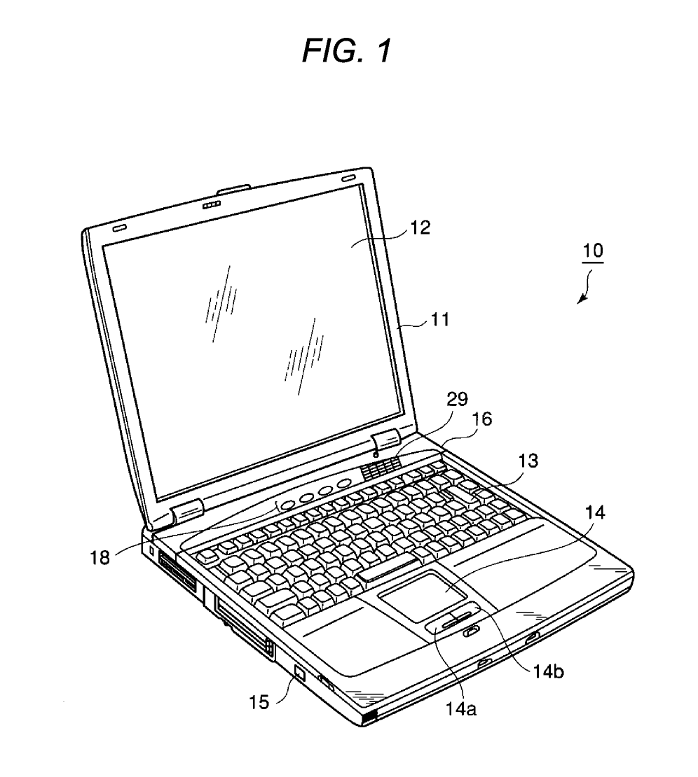

Embodiments will be hereinafter described with reference to the drawings. FIG. 1 is a perspective view of an information processing apparatus 10 according to a first embodiment, which is a notebook computer which can be driven by a battery.

As shown in FIG. 1, the notebook computer 10 is composed of a main body 16 and a display 11. The display 11 incorporates a display device which is an LCD (liquid crystal display). A display screen 12 of the LCD is located approximately at the center of the display 11.

The display 11 is attached to the main body 16 so as to be able to be opened and closed between an open position and a closed position. The main body 16 has a thin, box-shaped cabinet, and its top surface is provided with a keyboard 13, various buttons 18 such as shortcut buttons (e.g., mail button), a power button, and a sound volume control button, a speaker 29, a touch pad 14, two (left and right) buttons 14a and 14b, and other things. The touch pad 14 and the two buttons 14a and 14b are formed on a palm rest. The side surfaces of the main body 16 are provided with an optical drive 15 etc.

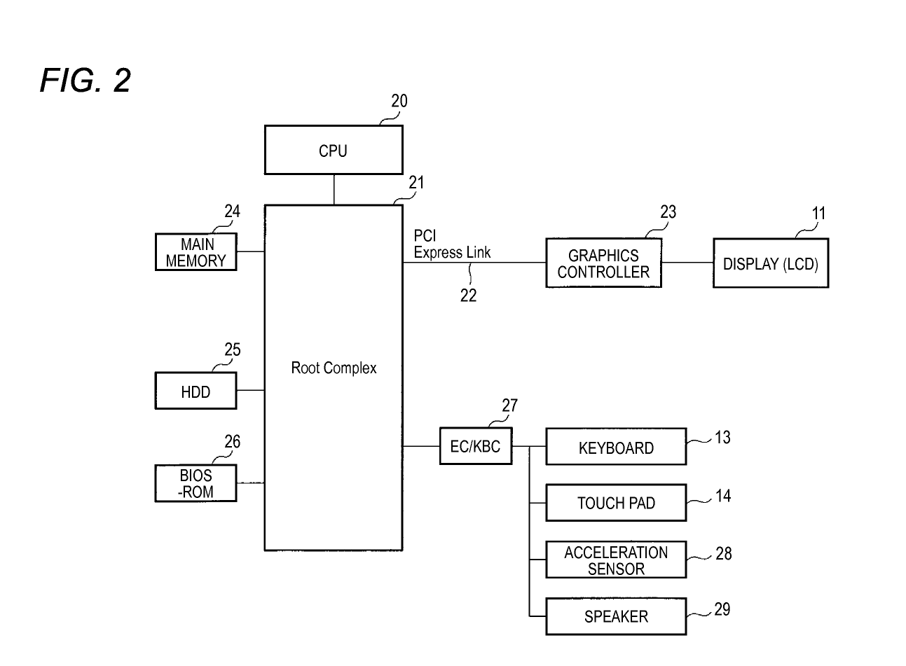

FIG. 2 is a block diagram showing the configuration of an essential part of the computer 10 according to the first embodiment. The computer 10 is equipped with a CPU (central processing unit) 20, a root complex (chip set) 21, a main memory 24, a graphics controller (end point) 23, a PCI Express link 22 which connects the root complex 21 and the graphics controller 23, the display 11 (LCD), an embedded controller/keyboard controller IC (EC/KBC) 27, a hard disk drive (HDD) 25, a BIOS-ROM 26, the keyboard 13, the touch pad 14, an acceleration sensor 28, the speaker 29, etc.

The root complex 21 and the graphics controller 23 are devices which comply with the PCI Express standard. A communication between the root complex 21 and the graphics controller 23 is performed via the PCI Express link 22 provided between them.

The CPU 20 is a processor which controls the operation of the computer 10, and runs various programs (operating system and application programs) that are loaded into the main memory 24 from the HDD 25. The CPU 20 also runs a BIOS (basic input output system) which is hardware control programs and is stored in the BIOS-ROM 26.

The root complex 21 is a bridge device which connects a local bus of the CPU 20 and the graphics controller 23. The root complex 21 also has a function of communicating with the graphics controller 23 via the PCI Express link 22.

The graphics controller 23 is a display controller for controlling the display 11 which is used as a display monitor of the computer 10.

The EC/KBC 27 is a one-chip microcomputer in which an embedded controller for power management and a keyboard controller for controlling the keyboard 13, the touch pad 14, the acceleration sensor 28, the speaker 29, etc. are integrated together. The EC/KBC 27 has, for example, a function of powering on/off the computer 10 through cooperation with a power controller in response to a user manipulation of the power button.

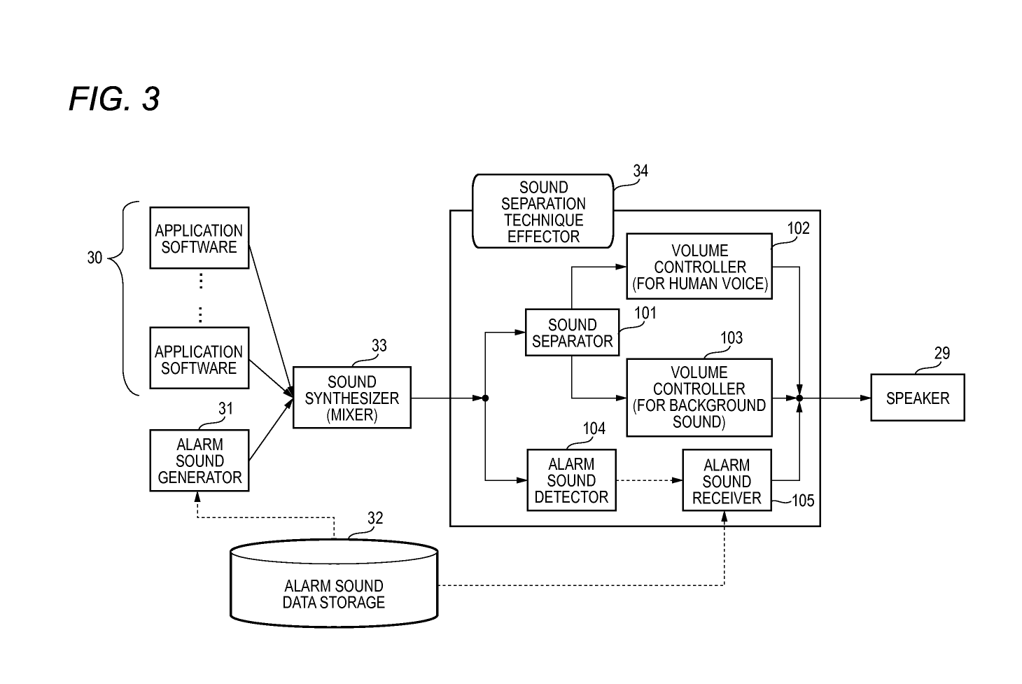

FIG. 3 is a functional block diagram of a system according to the first embodiment, which is realized by various programs (mainly application programs) which are loaded into the main memory 24 from the HDD 25. Application software 30 is various kinds of sound generation application software (e.g., music reproduction software, DVD reproduction software, and TV viewing software) to be run on the system. Plural kinds of sound generation application software can exist on the system.

The alarm sound generator 31 is software which allows the system to read alarm sound data from an alarm sound data storage 32, reproduce it, and alarm a user by a resulting sound. The alarm sound data storage 32 is a storage device (e.g., main memory 24 or HDD 25) which holds alarm sound data.

A sound synthesizer (mixier) 33 combines some of various sound signals which are generated by various kinds of application software of the application software 30 and the alarm sound generator 31 and are to be emitted from the system. A sound separation technique effector 34 performs audio signal processing using a sound separation technique, and is equipped with components 101-105 (see FIG. 3).

A sound separator 101 separates a received sound signal into a human voice signal and a background sound signal. For example, the technique disclosed in Japanese Patent No. 4,837,123 of the same applicant may be used for this purpose.

A volume controller 102 adjusts the volume of the separated human voice. For example, the volume controller 102 can reduce the volume of the human voice to make the background sound easier to hear.

A volume controller 103 adjusts the volume of the separated background sound. For example, the volume controller 103 can reduce the volume of the background sound to make the human voice easier to hear.

An alarm sound detector 104 detects (monitors) whether or not an alarm sound is being emitted by analyzing a sound signal that is input to the sound separation technique effector 34. For example, the alarm sound detector 104 analyzes a received sound signal through Fourier transform and thereby monitors whether or not a component having a frequency characteristic of an alarm sound is strong. Since in general there are various kinds of alarm sounds, a dictionary containing their frequency patterns may be prepared and referred to.

An alarm sound receiver 105 reads alarm sound data from the alarm sound data storage 32 and combines it with sound signals that are output from the volume controller 102 and 103.

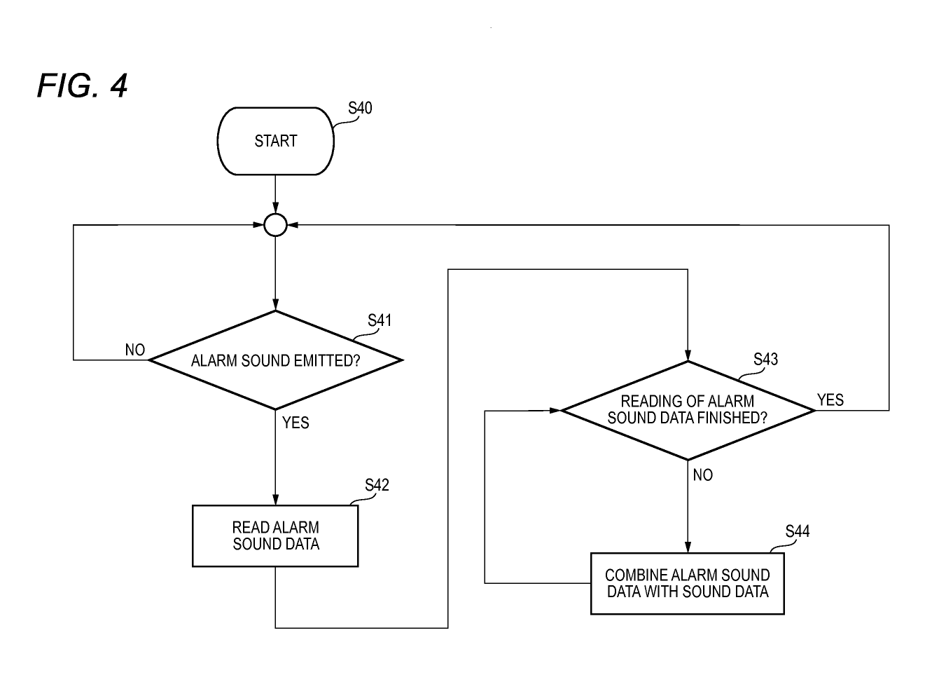

FIG. 4 is a flowchart of an audio signal process which is mainly executed by the CPU 20 in the first embodiment. At step S40, the audio signal process is start after power-on of the computer 10.

At step S41, whether an alarm sound is being emitted or not is monitored and judged using the alarm sound detector 104. If it is judged that an alarm sound is being emitted, the process moves to step S42. If not, the process returns to step S41.

At step S42 the alarm sound detector 104 instructs the alarm sound receiver 105 to read alarm sound data. Receiving the instruction, the alarm sound receiver 105 reads the alarm sound data.

At step S43, the alarm sound receiver 105 judges whether the reading of the alarm sound data has finished or not. If the judgment result is negative, the process moves to step S44. If the reading of the alarm sound data has finished, the process returns to step S41.

At step S44, the alarm sound receiver 105 combines the alarm sound data with sound data that are output from the volume controller 102 and 103. Since this process is a realtime audio signal process, the alarm sound data is combined with the sound data while the former is taken out from the head little by little. Therefore, the combining is performed at step S44 as the reading of the alarm sound data has finished or not is judged at step S43.

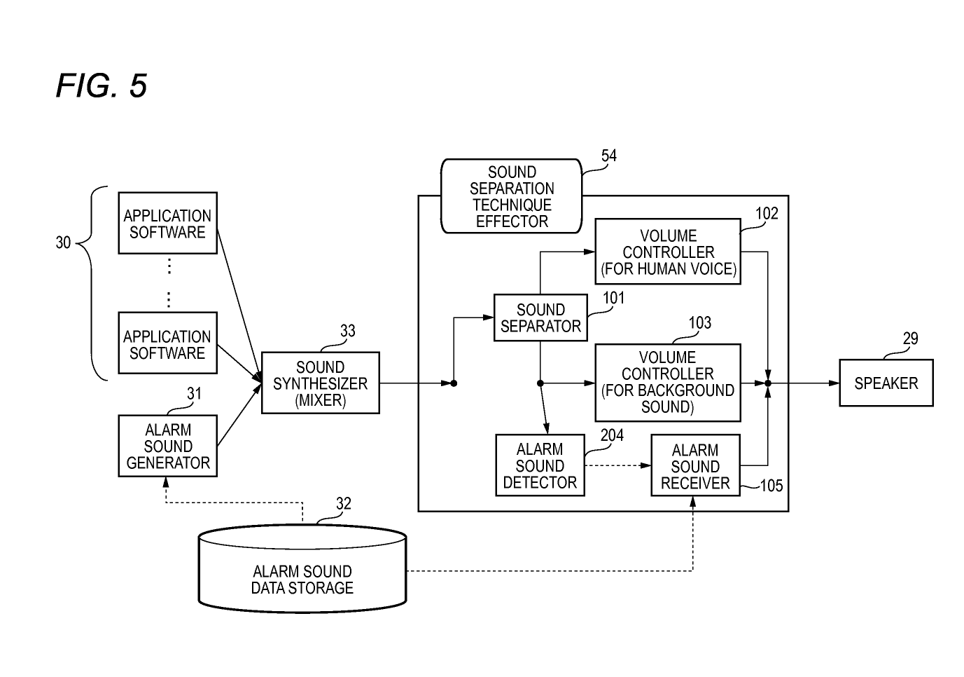

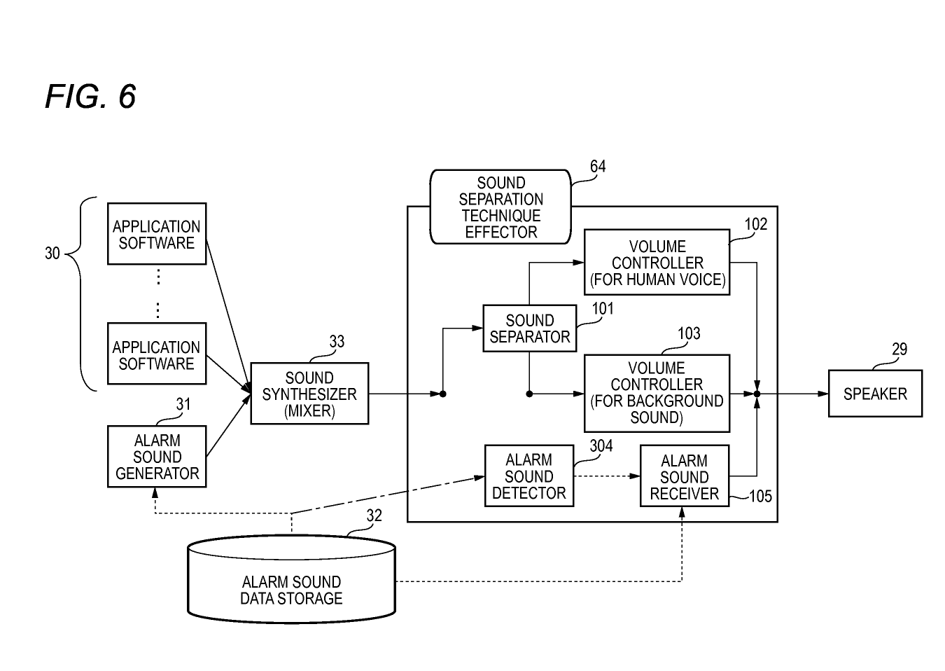

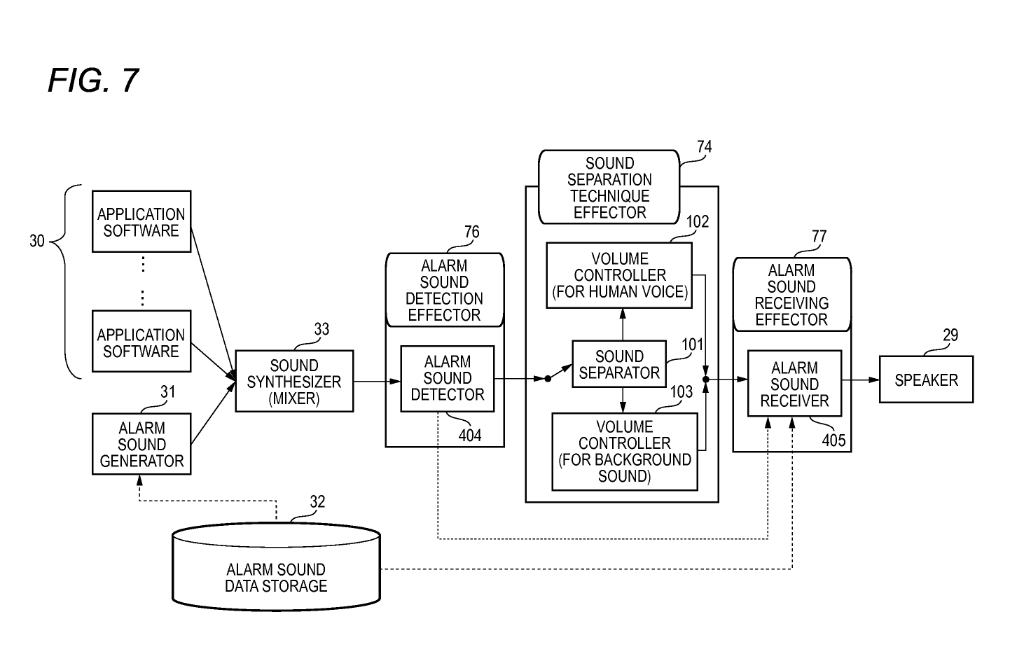

FIG. 5 is a functional block diagram of a system according to a second embodiment. Components having the same ones in FIG. 3 will not be described in detail (this also applies to FIGS. 6 and 7). A sound separation technique effector 54 is another exemplary effector which performs audio signal processing using a sound separation technique.

An alarm sound detector 204 detects (monitors) whether or not an alarm sound is being emitted by analyzing a background sound signal that is output from the sound separator 101. For example, the alarm sound detector 104 analyzes a received background sound signal through Fourier transform and thereby monitors whether or not a component having a frequency characteristic of an alarm sound is strong. If the quality of the background sound extraction by the sound separator 101 is high, it is expected that presence of an alarm sound can be detected more reliably than in the case using a sound that contains a human voice.

FIG. 6 is a functional block diagram of a system according to a third embodiment. A sound separation technique effector 64 is another exemplary effector which performs audio signal processing using a sound separation technique.

An alarm sound detector 304 detects (monitors) whether or not an alarm sound is being emitted by monitoring the operation that the alarm sound generator 31 reads alarm sound data from the alarm sound data storage 32. For example, where alarm sound data are stored in the form of files, the alarm sound detector 304 monitors whether reading of a file has started (i.e., the file has been opened) or not.

FIG. 7 is a functional block diagram of a system according to a fourth embodiment. A sound separation technique effector 74 is another exemplary effector which performs audio signal processing using a sound separation technique.

An alarm sound detection effector 76 and an alarm sound receiving effector 77 are individual effectors obtained by putting the alarm sound detector 104 and the alarm sound receiver 105 out of the sound separation technique effector 34. Because an alarm sound detector 404 of the alarm sound detection effector 76 has the same role as the alarm sound detector 104 or 304, and an alarm sound receiver 405 of the alarm sound receiving effector 77 has the same role as the alarm sound receiver 105, they will not be described in detail. (In FIG. 7, the alarm sound detector 404 and the alarm sound receiver 405 are drawn as examples different from the alarm sound detector 104 and the alarm sound receiver 105, respectively.) Where a system can be provided with plural effectors, separate effectors may be provided outside the sound separation technique effector 74 like the alarm sound detection effector 76 and the alarm sound receiving effector 77.

Each of the above-described embodiments is provided with a component which detects whether an alarm sound is being emitted in a state that an alarm sound signal is combined with another sound signal, and a component e which reads alarm sound data if it is detected that an alarm sound is being emitted. And a resulting alarm sound signal is combined with a sound-separation-processed output signal.

As such, each embodiment provides an advantage that can alleviate the phenomenon that an ordinary sound separation technique may make an alarm sound difficult to hear. Since an alarm sound signal is combined with other sound signals at the output stage, a user can hear a clearer alarm sound than in a case of extracting an alarm sound signal by filtering a sound signal.

Each embodiment is not such as to make an alarm sound easier to hear through filtering, that is, not such as to extract a notification sound (alarm sound) for a user by filtering. Therefore, an original alarm sound itself can be output from the speaker.

Each embodiment is directed to how an alarm sound being emitted should be detected and an alarm sound signal should be combined with a sound signal to be output to the speaker in a state that the alarm sound for a user is combined with another sound. Thus, each embodiment is effective even in the case that an alarm sound signal is combined with another sound signal. Only one audio signal processing path is sufficient.

The invention is not limited to the above embodiments, and can be variously modified without departing from the spirit and scope of the invention, for example, by combining plural components in each embodiment. Specifically, several ones of the components of each embodiment may be omitted, or components of different embodiments may be combined.

1. An information processing apparatus, comprising:
a sound synthesizer configured to output a combined sound signal of an alarm sound signal and a remaining sound signal other than the alarm sound signal;
a sound separator configured to separate the combined sound signal into a human voice signal and a background sound signal;
an alarm sound detector configured to detect whether a background sound corresponding to the background sound signal output from the sound separator includes an alarm sound or not; and
an alarm sound receiver configured to, when the alarm sound detector detects that the background sound includes the alarm sound,
read the alarm sound signal corresponding to the detected alarm sound, and
further combine the read alarm sound signal with the combined sound signal to thereby output an adjusted combined sound signal.

2. The apparatus of claim 1,
wherein the alarm sound detector detects whether the alarm sound is being emitted or not from the combined sound signal.

3. The apparatus of claim 1, further comprising:
an alarm sound data storage configured to hold alarm sound data,
wherein the alarm sound detector detects whether the alarm sound is being emitted or not by monitoring whether the held alarm sound data is being read or not.

4. A control method for controlling a sound signal output, the method comprising:
receiving a combined sound signal of an alarm sound signal and a remaining sound signal other than the alarm sound signal;
separating the combined sound signal into a human voice signal and a background sound signal;
detecting whether a background sound corresponding to the background sound signal output from the sound separator includes an alarm sound or not; and
when it is detected that the background sound includes the alarm sound,
reading the alarm sound signal corresponding to the detected alarm sound, and
further combining the read alarm sound signal with the combined sound signal to thereby output an adjusted combined sound signal.
